(19) United States
(12) Patent Application Publication
(10) Pub. No.: US 2007/0023198 A1
(43) Pub. Date: Feb. 1, 2007

(54) Gland

(75) Inventors: Lodewijk Van Noten, Leuven (BE); Roel Modest Willy Byron, Aarschot (BE); Kristof Vastmans, Boutersem (BE)

Correspondence Address: BAKER & DANIELS LLP, 300 NORTH MERIDIAN STREET, SUITE 2700, INDIANAPOLIS, IN, 46204, US

(73) Assignee: Tyco Electronics Raychem NV, Kessel-lo (BE)

(21) Appl. No.: 10/576,106

(22) PCT Filed: Oct. 27, 2004
(86) PCT No.: PCT/GB04/04518

§ 371 Date: Apr. 18, 2006

(30) Foreign Application Priority Data
Oct. 29, 2003 (GB) 0325202.0

(51) Int. Cl. H02G 15/02

(52) U.S. Cl. 174/77 R; 174/93

(57) ABSTRACT

A gland (10) for supporting one or more cables (29) comprises an annular gland body (11) defining a hollow passage (12) that is open at either end (12a, 12b). A core (13) is insertable into and removal from the passage via at least one of the ends (12a, 12b) thereof. The core includes a resiliently deformable member (21) that can be caused, by compression, to expand to occupy the passage (12). The gland body (11) includes one more formations (27) to which a said cable (29) inserted into the passage is securable thereby to permit insertion and removal of the core or components thereof relative to the gland body (11) without the core (11) straining any of the cables (29).

This invention relates to a gland for supporting one or more cables or other elongate conduits or objects all hereinafter denoted by the term “cables” for brevity.

By “gland” is meant any device that supports and/or divides one or more cables, when it is required for the cables to pass through a wall such as a bulkhead (eg. in a motor vehicle) or the wall of a connector housing (such as is used to enclose a splice or other kind of joint connecting cable ends together).

Such glands may be formed integrally with such walls; or they may be separate components that are insertable into apertures formed in such walls.

Further purposes of glands are to prevent the cables from becoming damaged (eg. by reason of chafing against the edge of an aperture formed in a wall); and to seal the aperture against ingress of eg. particulate matter and liquids, whilst permitting the cables to pass through the wall.

One area in which glands have, in recent years, become particularly important concerns that of optical fibre cables.

In the Western world, the rate of installation of such cables is increasing rapidly because they allow so-called “broadband” communication, for which conventional copper cables are essentially unsuitable.

Optical fibre cables are particularly good for the transmission of data, images and sound files using broadband techniques. However, they are also susceptible to damage.

One way in which optical fibre cables are readily damaged arises from straining of the cables.

Strain in an optical fibre cable causes microscopic cracking of the optical fibre material. This in turn causes a reduction in the data transmission efficiency of the cable.

Optical fibre cables typically are manufactured from silica glass. Under some circumstances the glass, and other materials forming parts of the cables, can be subject to chemical attack. Therefore there is a need for glands used to support optical fibre cables to exhibit good sealing properties preventing the ingress of particulate and liquid matter via a wall.

Of particular interest at present in the field of optical fibre cables is so-called “FTTH” (“Fibre To The Home”) cabling.

The idea of FTTH is to provide optical fibre cables directly to sockets in the homes of users of broadband internet technology.

FTTH installations involve replacing conventional copper or coaxial telephone cables, that hitherto have connected optical fibre “distribution” cables to consumers' houses, by so-called “drop” optical fibre cables.

The drop cables may be aerial drop cables (ie. those extending between transmission towers or poles and the consumers' homes); or underground drop cables.

In either case the drop cables, which are thinner and generally less well protected than the distribution cables, may be subject to strain in use.

Furthermore the underground cables may be subject to compression and/or chemical attack.

Several designs of gland are known that are suitable for use with optical fibre cables.

U.S. Pat. No. 4,267,401 discloses an arrangement in which a pair of compression plates sandwich between them of pair of resiliently deformable seal members.

A nut and bolt combination passes through a bore in the centre of the assembly, such that on tightening of the nut onto the bolt the compression members compress the resiliently deformable seal members.

The entire assembly is perforated at numerous points, to allow the passage therethrough of optical fibre or other cables. On tightening of the nut onto the bolt, the resiliently deformable members therefore bulge such that the material of the resiliently deformable seal members seals about any cables inserted into the perforations.

A disadvantage of this arrangement lies in the need for one or more pins. These require insertion into any of the perforations that in a given installation are unused.

The pins are needed because the bulging of the resiliently deformable seal member is not adequate to seal any of the perforations that are empty of cables.

WO-A-97/42693 and WO-A-97/38338 disclose arrangements in which it is not necessary to feed the cables via perforations in the gland assembly.

Rather, these publications disclose arrangements in which rigid, circular plates have formed therein slots that are open on the free edges of the plates and extend radially towards the centres thereof.

It is possible therefore to lay cables into the slots that serve as recesses for supporting the cables.

In WO-A-97/42693, at least one resiliently deformable member lies adjacent a said disc. Forcing of the resiliently deformable member into an annulus causes it to bulge adjacent the disc and thereby seal any cable lying in a said slot adjacent the inner wall of the annulus.

WO-A-97/38338 omits the resiliently deformable member and instead provides for separation of the strands of a bundle of cables, in a manner that permits their subsequent reorganisation.

WO-A-00/02295 is similar to the arrangement of WO-A-97/42693 in that at least one resiliently deformable member lies adjacent at least one rigid member having recesses formed in its outer periphery for receiving the cables.

In the arrangement of WO-A-00/02295 the cables are lain in the recesses and overlying the resiliently deformable member. The tying of fasteners such as cable ties around the assembly forces the cables into engagement with the resiliently deformable member. The assembly is then readily clampable within a housing containing eg. spliced connections, such that the resiliently deformable member seals around the cables.

A disadvantage of all of the aforesaid gland arrangements is that following assembly of the gland with cables inserted therethrough, the device requires substantial disassembly in order to add new cables.

This is an acute problem in the case of drop cables, since typically they include at their ends connectors that are bulky. It is not possible to pass the connectors through the typical size of passage defined in the gland, without first removing the rigid members and the resiliently deformable seal members that are commonly found in the prior art glands.

GB-A-2 262 392 discloses a seal for a cable pipe, in which a sealing element comprises a series of segments that are hingedly secured together.

Hinging of the segments to a particular configuration defines them as a circular structure having apertures through which cables may pass in a supported fashion.

The pipe in which the connector is installed is important for maintaining the circular configuration of the support element.

In view of the foregoing there is a need for a gland that is suitable for use with drop cables.

According to a first aspect of the invention there is provided a gland for supporting one or more cables, comprising:
an annular gland body defining a hollow passage that is open at either end; and
a core that is insertable into and removable from the passage via at least one open end thereof, the core including at least two moveable compression members that are spaced from one another; a resiliently deformable member lying between the compression members; and a selectively operable actuator for selectively moving the compression members towards one another to compress the resiliently deformable material and cause it to bulge outwardly of the compression members, at least one of the core and the passage including defined therein one or more recesses for supporting a cable inserted in the passage, and the annular gland body including one or more formations to which a said cable inserted into the passage is securable thereby to permit insertion and removal of the core relative to the gland body without dislodging any said cable already inserted in the gland.

The combination of a removable core and one or more formations to which a previously inserted cable is securable advantageously permits the insertion of additional cables through the gland, without causing damage to previously installed cables and without occasioning extensive dismantling of the gland assembly.

In practical, preferred embodiments of the invention the gland includes a plurality of the recesses and a corresponding plurality of the formations.

Even more preferably the gland body is circular in cross section, and the recesses are in a circular pattern that is generally concentric with the gland body when viewed in cross section.

Although this is a preferred arrangement, other cross-sectional shapes of the gland, such as ovals, are possible.

Conveniently the or each said formation includes a protuberance projecting from a said open end of the gland body.

Even more preferably there is at least one said protuberance projecting from each said open end of the gland body.

These features allow the fastening of each inserted cable to the gland body at either end thereof, thereby improving the overall stability of the device and consequently reducing the risk of inducing strain in optical fibre cables.

Preferably the core and the passage together define the or each recess.

In preferred embodiments this is achieved by reason of each of the core and the passage having defined therein one or more semi-cylindrical recesses that pairs of which, when mutually aligned, define essentially cylindrical, elongate recesses.

It is also preferable that the gland of the invention includes a layer of a resiliently deformable material on the inner surface of the hollow passage.

This feature advantageously assists in sealing of the cable in the gland.

In some embodiments of the invention the gland body includes two or more gland body parts that are hingedly secured one to another whereby the gland body is hingedly alterable between an annular configuration and a discontinuous, non-annular configuration in which at least two portions of respective said body parts are spaced from one another.

Thus it is possible to incorporate into the gland of the invention a supporting member of the general kind disclosed in GB-A-2 262 392.

Preferably when so configured the gland includes a fastening for selectively fastening the gland body parts in the said annular configuration.

Consequently, in contrast to the arrangement of GB-A-2 262 392, it is not necessary to rely on a cable pipe for supporting the gland body parts in their annular configuration.

Optionally the gland includes a rod received in one or more of the said recesses.

Such a rod is desirable when the number of cables requiring supporting in the gland is less than the overall number of recesses defined therein.

The rods are solid, and thereby close off any unused recesses that might not otherwise be sealed by bulging of the resiliently deformable member.

It is within the scope of the invention for a gland as defined hereinabove to include a flexible, elongate member (eg. any kind of cable including but not limited to optical fibre cables such as drop cables) received in the or a said recess and secured by a fastener to at least one formation, the core being received in the said hollow passage and the compression members compressing the resiliently deformable member to cause it to bulge outwardly of the compression members into sealing engagement with the flexible, elongate member.

In other words, the invention embraces within its scope a gland as defined herein when configured to support a cable or similar, flexible, elongate member.

According to a further aspect of the invention, there is provided a method of inserting one or more cables into a gland as defined hereinabove comprising the steps of:
(i) as necessary, operating the actuator member so as to space the compression members from one another to allow relaxation of the resiliently deformable member;
(ii) removing the core from the passage;
(iii) inserting one or more cables into the passage;
(iv) securing the or each cable to a respective formation using a fastener;
(v) inserting the core into the passage so that the or each said cable lies on or adjacent the exterior of the core; and
(vi) operating the actuator to cause compression of the resiliently deformable member until it bulges outwardly of the compression members into sealing engagement with the or each said cable.

Optionally the method includes the step of aligning the or each said cable into at least one of the recesses.

A further, optional step of the method of the invention includes the step of inserting a rod into one or more of the recesses. This latter, optional step, is of course only needed in the event of one or more of the recesses remaining unoccupied by cables.

There now follows a description of preferred embodiments of the invention, by way of non-limiting example, with reference being made to the accompanying drawings in which:

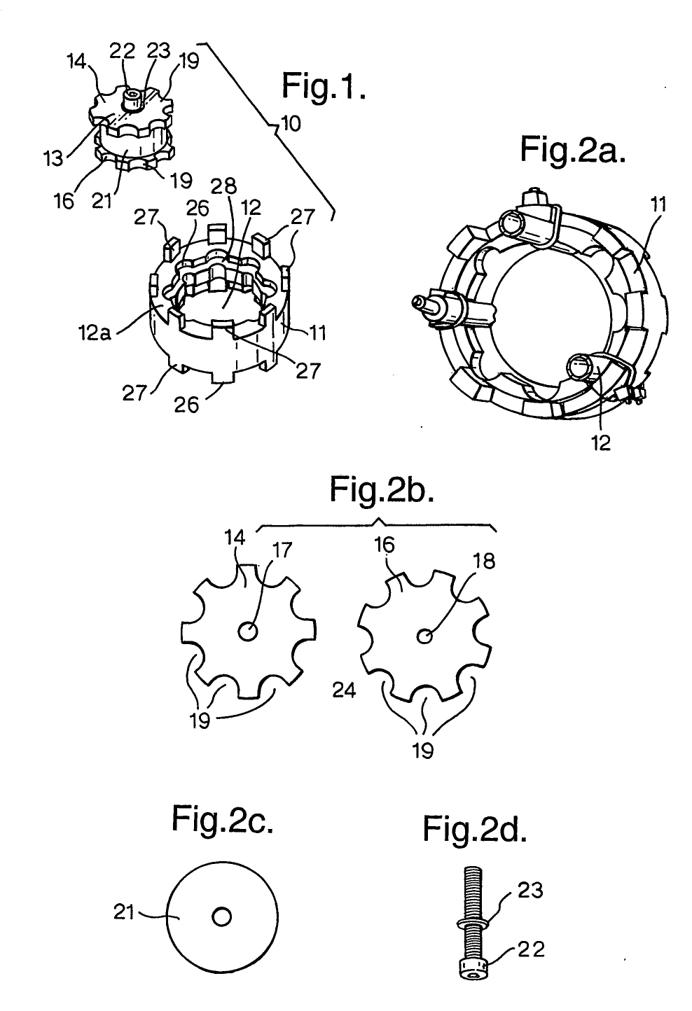

FIG. 1 is a perspective view of a gland according to the invention, showing a core thereof separated from a gland housing thereof;

FIGS. 2a, 2b, 2c and 2d show the parts of the FIG. 1 apparatus separated from one another before assembly of the gland;

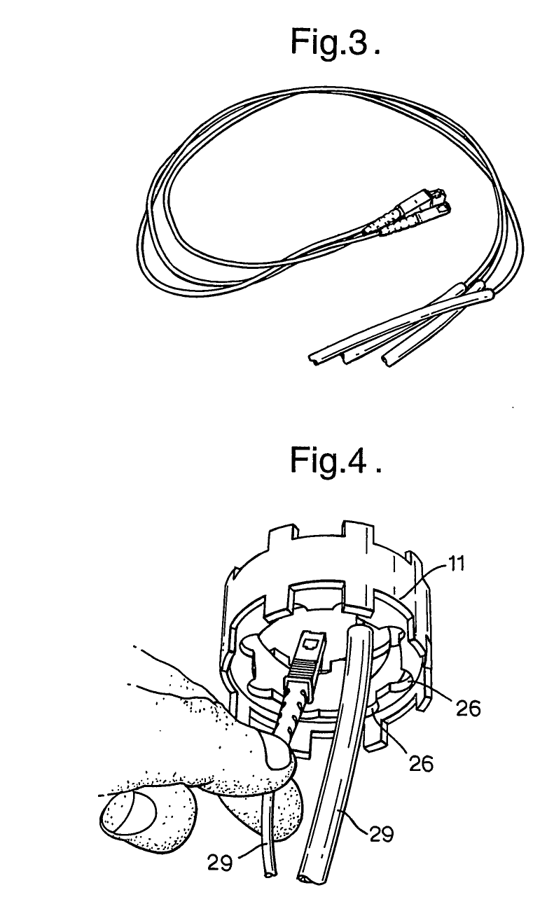

FIG. 3 shows a typical drop cable for which the gland is particularly suited; and

FIGS. 4 to 7 show the steps in the assembly of the gland to support a drop cable such as that shown in FIG. 3.

A gland 10 according to the invention, for supporting one or more cables, is shown in the drawing figures.

Gland 10 is suitable for supporting any of a range of cable types including copper cables, coaxial cables and optical fibre cables.

Gland 10 is particularly suited, as stated herein, for sealingly supporting optical fibre cables of the drop-type.

Gland 10 comprises an annular gland body 11 that in the preferred embodiment shown is a hollow, rigid cylinder.

Thus gland body 11 defines a hollow, cylindrical passage 12 that is open at either end 12a, 12b of gland body 11.

Gland 10 also includes a core 13 that is insertable into and removable from the passage 12 via at least one of the ends 12a, 12b thereof.

In practice passage 12 is of constant diameter along its length, whereby core 13 is insertable via either of the ends 12a, 12b.

Core 13 includes two movable compression members 14, 16.

The compression members 14, 16 (that are best shown in FIG. 2b) are rigid discs formed preferably but not essentially of an insulative material.

Each compression member 14, 16 has a through-going bore 17, 18.

The periphery of each disc 14, 16, includes formed therein an annular series of semi-cylindrical recesses 19.

The discs 14, 16 are in the preferred embodiment shown of the same diameter as one another, but this need not necessarily be so.

In the core 13 the compression members 14, 16 are spaced from one another with a resiliently deformable member 21 lying therebetween.

Resiliently deformable member 21 is an annulus or “doughnut” of eg. a gel or a similar material that deforms when compressed.

In its uncompressed state the annulus of resiliently deformable member 21 is of a lesser external diameter than the diameter of the compression members 14, 16.

Core 13 includes an actuator for causing compression of the resilient deformable member 21.

The actuator is in the form of a bolt 22, shake-proof washer 23 and nut 24 combination.

The bolt 22 passes through the respective bores 17, 18 (the latter of which has secured therein the nut 24) and defines a central axis for the generally cylindrical core 13.

The threaded end of bolt 22 is threadedly engaged in nut 24. Shake-proof washer 23 is interposed between the head of bolt 22 and compression member 14.

The arrangement is such that on tightening of bolt 22 into nut 24, the actuator constituted thereby urges the compression members 14, 16 closer together with the result that they compress the resiliently deformable member 21.

This causes bulging of the material of the resiliently deformable member 21 so that it protrudes outwardly of the compression members 14, 16 to a diameter that is an interference fit with the interior of passage 12.

In the particular embodiment shown in the representations, the passage 12 also has formed therein, on its inner wall, an annular series of semi-cylindrical recesses 26.

These are such that when the core 13 is inserted in passage 12 pairs of the recesses 19, 26 formed respectively in the core and the passage 12 when mutually aligned define essentially cylindrical supporting channels extending from one end of the gland 10 towards the other.

For this reason the number of recesses defined in the wall of passage 12 is the same as the number of recesses defined in the compression members 14, 16.

The gland body 11 includes protruding from each end an annular series of arcuate, essentially laminar formations 27.

The number of formations equals the number of semi-cylindrical recesses 26. Each formation 27 protrudes from an end 12a, 12b of passage 12 adjacent a said recess.

The purpose of the formations is to permit securing (eg. by tying) thereto a cable supporting in an adjacent recess, thereby permitting removal of the core 13 relative to the gland body 11, without the gland body inducing strain in the cable.

This operation is described in more detail hereinbelow.

A further, optional feature of the gland of the invention is a layer 28 of resiliently deformable material (eg. a gel or a similar material) coated on the inner wall of passage 12. The purpose of the layer 28 of resiliently deformable material is to improve sealing of the gland about cables supported therein.

Optionally the gland body 11 may comprise a series of hingedly interconnected arcuate members that are hingeable from a discontinuous, non-annular configuration defining a gap between two ends through which a cable or similar object may be passed radially into the passage 12; and an annular configuration in which the elements abut one another and the annulus is continuous.

Further such an arrangement may include a fastener for fastening the elements in the annular configuration as desired.

A method of inserting the cable into the gland 10 of the invention will now be described.

A typical cable intended for use in the gland 10 is a drop cable 29 as shown in FIG. 3.

In practice the user would assemble a series of the cables 29 into the gland 10.

Each drop cable 29 shown in FIG. 3 terminates in a connector 31. Clearly when considering a bundle of the cables 29 the resulting plurality of connectors 31 is too bulky readily to be insertable into and removable from any of the glands of the prior art described herein.

The steps in the assembly of the cable into the gland include, initially, as necessary unscrewing the bolt 22 (ie. operating the actuator) so as to ensure that the resiliently deformable member 21 is in its uncompressed state.

Consequently the maximum diameter of the core 13 is then defined by the compression members 14, 16 and the core 13 is readily removable from the passage 12.

With the core thus removed (as shown in FIGS. 1 and 4) it is possible to feed a desired number of the cables 29 via the passage 12, even if they terminate in bulky connectors as shown.

This stage of the assembly operation in the preferred embodiment shown involves laying each cable into one of the cylindrical recesses 26 defined in the inner wall of passage 12.

In this configuration each cable 29 rests on the layer 28 of resiliently deformable material formed on the inner surface of passage 12.

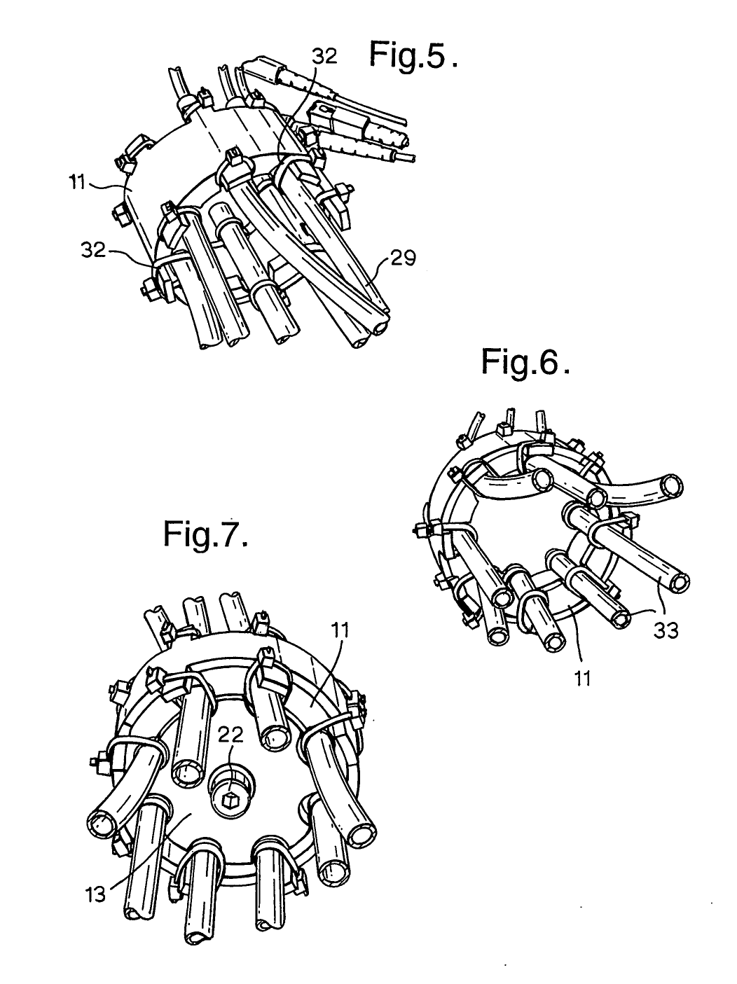

Thereafter, as best shown in FIG. 5, each cable 29 is secured at either end of gland body 11 to a respective formation 27 protruding adjacent the cylindrical recess 26 in which the said cable is received.

One convenient way of securing the cables 29 to the formations 27 is by the use of per se known cable ties 32.

Other fasteners for securing the cables 29 to the formations 27 are of course possible. These include but are not limited to eg. threads, tapes (which may be adhesive or non-adhesive), adhesive compounds (e.g. that cure in air) and foldable, deformable or otherwise moveable parts of the formations 27.

Since in the preferred embodiment shown there is a formation 27 at each end of passage 12, each cable 29 is secured to the gland body 11 at two axially spaced locations, thereby enhancing the robustness of the assembly.

Once the requisite number of cables 29 has been secured to the formations 27, as shown in FIG. 6 any of the unoccupied, cylindrical recesses 26 defined in passage 12 are filled with rigid rods 33 that are of the same diameter as the cables 29.

The rods preferably are made of an insulative material. They are secured in the semi-cylindrical recesses 26 using cable ties or other, similar fasteners, in the same manner as the cables 29.

Thereafter, as shown in FIG. 7, the core 13 is inserted into the passage 12.

This may be achieved in either of two ways.

Either the complete core can be inserted, as a unit, via one of the ends 12a, 12b of the passage 12.

Alternatively, the components shown separated in FIG. 2 can be brought one at a time into the passage 12, and the core 13 assembled in situ.

Regardless of the precise method of inserting the core 13, it is necessary then only to tighten the bolt 22 into the nut 24 thereby causing bulging of the resiliently deformable member 21 outwardly beyond the compression members 14, 16.

The resiliently deformable member 21 thereby sealingly engages the cables 29 and any rods 33 present, completing the gland.

This action causes the cables 29 and any rods 33 to become urged into the layer 28 of resiliently deformable material, thereby assuring a particulate-proof and liquid-proof seal.

Of course in practical use of the gland the gland body 11 would be supported eg. in an aperture in a wall, in the manner described hereinabove.

It is possible readily to remove the core 13 from the gland, via a reversal of the core compression and insertion steps described hereinabove.

By reason of the cables 29 being fastened as either end of aperture 12 to the formations 27, such removal of the core, even though it involves removing core components axially along the cylindrical passage 12, minimises or even eliminates the impossible of strain on the cables 29. Consequently the damage to the cables 29 is also kept to a minimum.

1. A gland for supporting one or more cables, comprising:
an annular gland body defining a hollow passage that is open at either end; and
a core that is insertable into and removable from the passage via at least one open end thereof, the core including at least two moveable compression members that are spaced from one another; a resiliently deformable member lying between the compression members; and a selectively operable actuator for selectively moving the compression members towards one another to compress the resiliently deformable material and cause it to bulge outwardly of the compression members, at least one of the core and the passage including defined therein one or more recesses for supporting a cable inserted in the passage, and the annular gland body including one or more formations to which a said cable inserted into the passage is securable thereby to permit insertion and removal of the core relative to the gland body without dislodging any said cable already inserted in the gland.

2. A gland according to claim 1 including a plurality of the recesses and a corresponding plurality of the formations.

3. A gland according to claim 2 wherein the gland body is circular in cross section and the recesses are in a circular pattern that is generally concentric with the gland body when viewed in cross section.

4. A gland according to any preceding claim wherein the or each said formation includes a protuberance projecting from a said open end of the gland body.

5. A gland according to claim 4 including at least one said protuberance projecting from each said open end of the gland body.

6. A gland according to any preceding claim wherein the core and the passage together define the or each recess.

7. A gland according to any preceding claim including a layer of a resiliently deformable material on the inner surface of the hollow passage.

8. A gland according to any preceding claim wherein the gland body includes two or more gland body parts that are hingedly secured one to another whereby the gland body is hingedly alterable between an annular configuration and a discontinuous, non-annular configuration in which at least two portions of respective said body parts are spaced from one another.

9. A gland according to claim 8 including a fastener for selectively fastening the gland body parts in the said annular configuration.

10. A gland according to claim 2 or any preceding claim depending therefrom including a rod received in one or more said recesses.

11. A gland according to any preceding claim including a flexible, elongate member received in the or a said recess and secured by a fastener to at least one formation, the core being received in the said hollow passage and the compression members compressing the resiliently deformable member to cause it to bulge outwardly of the compression members into sealing engagement with the flexible, elongate member.

12. A gland according to any preceding claim, having one or more said cables inserted and secured therein.

13. A gland according to any preceding claim, when acting as an inlet or outlet of a cable splice housing.

14. A method of inserting one or more cables into a gland according to any preceding claim comprising the steps of:
(i) as necessary, operating the actuator member so as to space the compression members from one another to allow relaxation of the resiliently deformable member;
(ii) removing the core from the passage;
(iii) inserting one or more cables into the passage;
(iv) securing the or each cable to a respective formation using a fastener;
(v) inserting the core into the passage so that the or each said cable lies on or adjacent the exterior of the core; and
(vi) operating the actuator to cause compression of the resiliently deformable member until it bulges outwardly of the compression members into sealing engagement with the or each said cable.

15. A method according to claim 14 including, before carrying out Step (vi), the step of placing the or each said cable into at least one recess.

16. A method according to claim 14 or claim 15 including, before carrying out Step (vi), the step of inserting a rod into one or more said recesses.

17. A gland generally as herein described, with reference to and/or as illustrated in the accompanying drawings.

18. A method generally as herein described, with reference to and/or as illustrated in the accompanying drawings.
